(19) United States
(12) Patent Application Publication
(10) Pub. No.: US 2009/0128453 A1
(43) Pub. Date: May 21, 2009

(54) Plasma display device and driving apparatus and method thereof

(76) Inventor: Soo-Yon Moun, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/289,757

(22) Filed: Nov. 3, 2008

(30) Foreign Application Priority Data
Nov. 16, 2007 (KR) 10-2007-0117274

(51) Int. Cl. G09G 3/28

(52) U.S. Cl. 345/60; 345/204

(57) ABSTRACT

A plasma display device having a plurality of address electrodes; a controller that divides a frame into a plurality of subfields each having a weight value, and converts an input video signal into a plurality of subfield data that represent turn-on/turn-off for respective subfields; a timing controller that receives the plurality of subfield data and outputs the plurality of subfield data and a driving control signal; a first group of data drivers that, in response to the driving control signal, generate display data to be applied to a first group of corresponding address electrodes among the plurality of address electrodes by sequentially sampling corresponding subfield data among the plurality of subfield data, and then output a carry signal; and a second group of data drivers that, in response to the carry signal, generate display data to be applied to a second group of corresponding address electrodes among the plurality of address electrodes.

### CLAIM OF PRIORITY

This application makes reference to, incorporates the same herein, and claims all benefits accruing under 35 U.S.C. §119 from an application for PLASM, DISPLAY, DRIVING APPARATUS, AND DRIVING METHOD THEREOF earlier filed in the Korean Intellectual Property Office on 16 Nov. 2007 and there duly assigned Serial No. 10-2007-0117274.

### BACKGROUND OF THE INVENTION

1. Field of the Invention

The present invention relates to a plasma display device and driving apparatus and method thereof. More particularly, the present invention relates to a plasma display device and driving apparatus and method thereof that enable preventing an erroneous operation of a data driver.

2. Description of the Related Art

A plasma display device is a flat panel display that uses plasma generated by gas discharge to display characters or images. A display panel of the plasma display device includes, depending on its size, more than several scores to millions of discharge cells (hereinafter, simply called cells) arranged in a matrix pattern.

The plasma display device is driven by dividing one frame into a plurality of subfields each having a grayscale weight value. In this case, luminance of a discharge cell is determined by a sum of the grayscale weight values of subfields.

In addition, each subfield includes a reset period, an address period, and a sustain period. The reset period is for initializing a wall charge state of each discharge cell, and the address period is for performing an addressing operation so as to select turn-on cells. The sustain period is for displaying an image by sustain-discharging the turn-on cells selected in the address period for a period that corresponds to the weight value of the corresponding subfield.

In the reset period, the wall charge state is initialized through a weak discharge induced by applying a gradually decreasing voltage waveform to a scan electrode after applying a gradually increasing voltage waveform (hereinafter called a reset rising waveform) to a scan electrode. In the sustain period, the sustain discharge is induced at the turn-on cells by applying a sustain pulse with an opposite phase to a scan electrode and a sustain electrode.

The plasma display device employs a driving circuit for driving an address electrode in order to perform an address operation. The driving circuit includes a timing controller that generates a driving control signal for the control of a plurality of data drivers and a plurality of data.

Recently, the plasma display panel tends to become larger. This causes an increase of the number of data drivers included in the driving circuit, and thereby a deviation of a distance between the timing controller and data drivers becomes greater. Such a deviation of distance may become a main cause of sampling error of the data driver in that it may cause a skew of the driving control signal inputted from the timing controller to each data driver.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device and driving apparatus and method thereof having advantages of preventing a sampling error.

An exemplary embodiment of the present invention provides plasma display device that includes: a plurality of address electrodes; a controller that divides a frame into a plurality of subfields each having a weight value, and converts an input video signal into a plurality of subfield data that represent turn-on/turn-off for respective subfields; a timing controller that receives the plurality of subfield data and outputs the plurality of subfield data and a driving control signal; a first group of data drivers that, in response to the driving control signal, generate display data to be applied to a first group of corresponding address electrodes among the plurality of address electrodes by sequentially sampling corresponding subfield data among the plurality of subfield data, and then output a carry signal; and a second group of data drivers that, in response to the carry signal, generate display data to be applied to a second group of corresponding address electrodes among the plurality of address electrodes.

An exemplary embodiment of the present invention provides driving apparatus of a plasma display device that includes: a plurality of data drivers that generate display data by sequentially sampling inputted subfield data and apply the generated display data to corresponding address electrodes among the plurality of address electrodes, the plurality of data drivers being grouped into a plurality of groups each including at least two data drivers; and a timing controller that supplies the subfield data to respective ones of the plurality of data drivers,

The timing controller may supply a first control signal for a sampling operation to a first data driver among data drivers of each group. The first data driver may generate a second control signal for a sampling operation and supply the second control signal to a second data driver arranged closest to the first data driver in the same group with the first data driver.

An exemplary embodiment of the present invention provides a driving method of a plasma display device for applying a display data signal to a plurality of address electrodes. The driving method includes: outputting a driving control signal; sequentially sampling subfield data inputted in response to the driving control signal and storing the sampled subfield data in a first data driver; generating a carry signal when the sampling of the first data driver is finished; sequentially sampling subfield data inputted in response to the carry signal and storing the sampled subfield data in a second data driver; converting subfield data stored in the first and second data drivers to the display data signal; and applying the display data signal to the plurality of address electrodes.

According to an exemplary embodiment of the present invention, a sampling error may be prevented, and thus an erroneous operation of a data driver may be prevented.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a timing controller and a data driver included in a driving circuit.

FIG. 2 is a block diagram of a plasma display device according to an exemplary embodiment of the present invention.

FIG. 3 shows an address electrode driver according to a first exemplary embodiment of the present invention.

FIG. 4 shows a data driver according to an exemplary embodiment of the present invention.

FIG. 5 shows an address electrode driver according to a second exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising”, will be understood to imply the inclusion of stated elements but not the exclusion of any other elements.

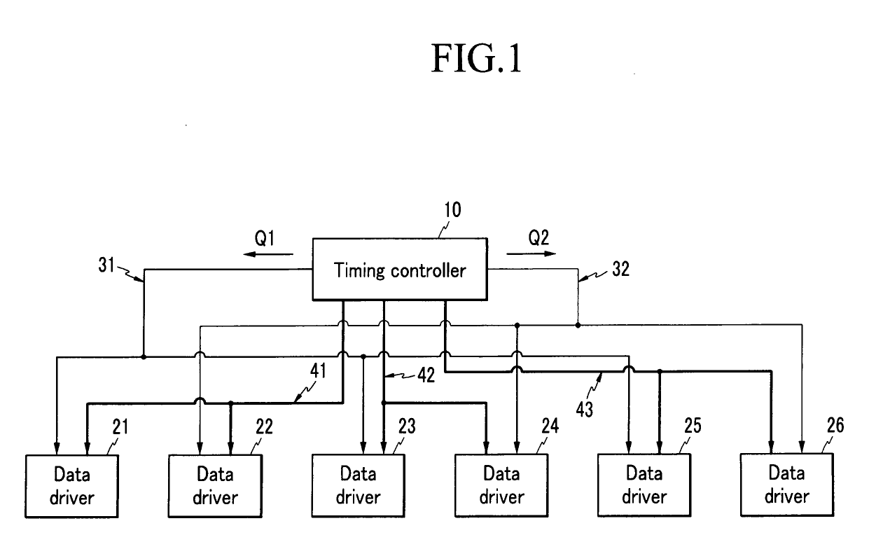

A plasma display device employs a driving circuit for driving an address electrode in order to perform an address operation. The driving circuit includes a timing controller that generates a driving control signal for the control of a plurality of data drivers and a plurality of data drivers, and the timing controller is shown in FIG. 1.

FIG. 1 shows a timing controller 10 and a data driver 21-26 included in a driving circuit.

As shown in FIG.1, a driving circuit includes a timing controller 10 and a plurality of data drivers 21-26.

The timing controller 10 sends driving control signals Q1 and Q2 and data for controlling operation/non-operation of the data drivers 21-26 to the data drivers 21-26. In more detail, timing controller 10 simultaneously applies the driving control signal Q1 to odd numbered data drivers 21, 23, and 25 among the data drivers 21-26 through a first driving control signal line 31. In addition, the timing controller 10 simultaneously applies the driving control signal Q2 to even numbered data drivers 22, 24, and 26 among the data drivers 21-26 through a second driving control signal line 32.

The timing controller 10 sends the data to adjacent pairs of data drivers 21 and 22, 23 and 24, and 25 and 26 through data lines 41, 42, and 43, respectively.

The timing controller 10 oppositely controls the driving control signal Q1 and the driving control signal Q2. That is, when the driving control signal Q1 is “Enable”, the driving control signal is Q2 is “Disable”, and when the driving control signal Q1 Disable, the driving control signal Q2 is Enable.

When the driving control signal Q1 is Enable, the odd numbered data drivers 21, 23, and 25 samples data received from the timing controller 10. When the driving control signal Q2 is Enable, the even numbered data drivers 22, 24, and 26 samples data received from the timing controller 10. As described above, the timing controller 10 sends the data to adjacent pairs of data drivers 21 and 22, 23 and 24, and 25 and 26 through respective data lines 41, 42, and 43. For each pair of data drivers connected to respective data lines, one is enabled and another is disabled through the driving control signal lines 31 and 32, such that they may operate at different time points.

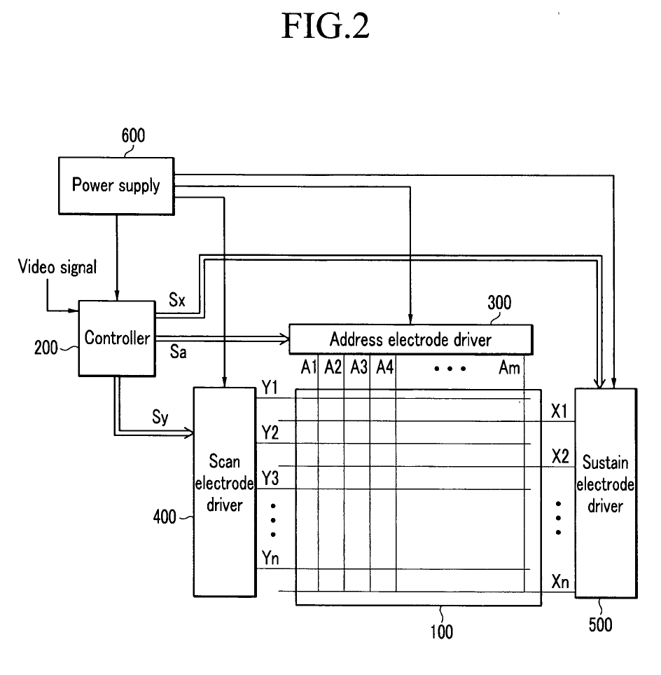

Hereinafter, a plasma display device and driving apparatus and method thereof according to an exemplary embodiment of the present invention is described in detail with reference to drawings. FIG. 2 is a block diagram of a plasma display device according to an exemplary embodiment of the present invention.

As shown in FIG. 2, a plasma display device according to an exemplary embodiment of the present invention includes a plasma display panel (PDP) 100, a controller 200, an address electrode driver 300, a scan electrode driver 400, a sustain electrode driver 500, and a power supply 600.

The PDP 100 includes a plurality of address electrodes A1-Am extending in a column direction; and a plurality of sustain electrodes X1-Xn and scan electrodes Y1-Yn extending in a row direction by pairs. The sustain electrodes X1-Xn are formed correspondingly to the scan electrodes Y1-Yn. Typically, according to the present invention, they are commonly connected with each other.

The PDP 100 includes a substrate (not shown) where the sustain electrodes X1-Xn and the scan electrodes Y1-Yn are arranged and another substrate (not shown) where the address electrodes A1-Am are arranged. The two substrates are placed facing each other with a discharge space therebetween so that the scan electrodes Y1-Yn and the address electrodes A1-Am may perpendicularly cross each other and the sustain electrodes X1-Xn and the address electrodes A1-Am may perpendicularly cross each other. The discharge space formed at a crossing region of the address electrodes A1-Am and the sustain and scan electrodes X1-Xn and Y1-Yn forms a discharge cell. This is an exemplary structure of the PDP 100 and panels of other structures can be applied to the present invention.

The controller 200 receives external video signals and outputs an address electrode driving control signal Sa, a sustain electrode driving control signal Sx, and a scan electrode driving control signal Sy. In addition, the controller 200 divides one frame into a plurality of subfields having respective weight values and drives the subfields, and each subfield includes a reset period, an address period, and a sustain period with respect to time. The controller 200 converts an input video signal to subfield data that represent turn-on/turn-off (i.e., light emitting/non-light emitting) of respective subfields. For example, when a frame is divided into eight subfields respectively having weight values of 1, 2, 4, 8, 16, 32, and 128, a subfield data that represent a grayscale 115 may be “11001110”. Here, “0” means a turn-off of a corresponding subfield, and “1” means a turn-on thereof. According to the subfield data “11001110”, a cell is turned on at first, second, fifth, sixth, and seventh subfields SF1, SF2, SF5, SF6, and SF7 in order to realize the grayscale 115.

The address electrode driver 300 receives the address electrode driving control signal Sa and subfield data from the controller 200 and applies a display data signal to each address electrode so as to select turn-on cells and turn-off cells from among cells.

The scan electrode driver 400 receives the scan electrode driving control signal Sy from the controller 200 and applies a driving voltage to a scan electrode Y1-Yn.

The sustain electrode driver 500 receives the sustain electrode driving control signal Sx from the controller 200 and applies a driving voltage to a sustain electrode X1-Xn.

The power supply 600 supplies power for driving the plasma display device to the controller 200 and the respective drivers 300, 400, and 500.

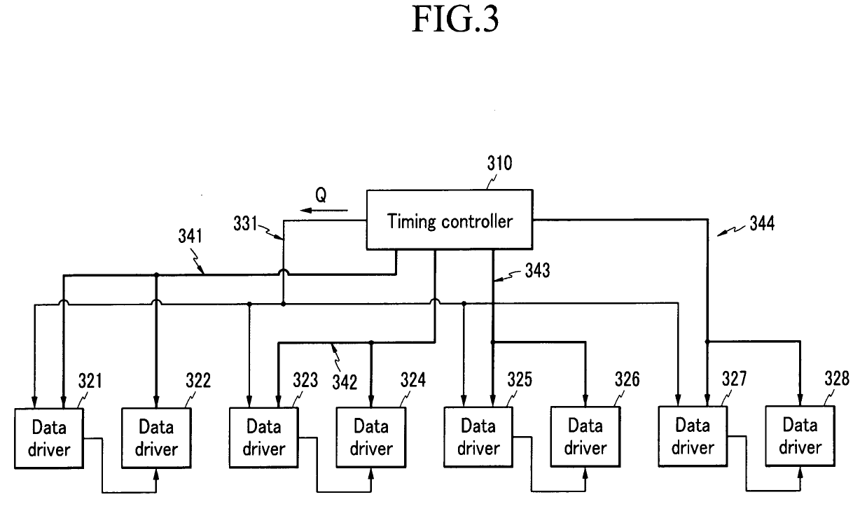

Hereinafter, an address electrode driver 300 according to a first exemplary embodiment of the present invention is described in detail with reference to FIG. 3.

FIG. 3 shows an address electrode driver 300 according to a first exemplary embodiment of the present invention.

As shown in FIG. 3, the address electrode driver (300 in FIG. 2) according to the first exemplary embodiment of the present invention includes a timing controller 310 and a plurality of data drivers 321-328, and it is assumed that each data driver corresponds to 32 address electrodes. It should be understood that the number of the data drivers 321-328 in FIG. 3 is merely an exemplary one for better understanding and ease of description, and the address electrode driver 300 according to an exemplary embodiment of the present invention may include a different number of data drivers.

The timing controller 310 receives an address electrode driving control signal (Sa in FIG. 2) and subfield data from the controller (200 in FIG. 2), and then generates a driving control signal Q for controlling operation/non-operation of odd numbered data drivers 321, 323, 325, and 327 among the data drivers 321-328 in the address electrode driver 300.

The timing controller 310 simultaneously applies the driving control signal Q to the odd numbered data drivers 321, 323, 325, and 327 through a driving control signal line 331. In addition, for each subfield, the timing controller 310 sequentially transmits a same subfield data to adjacent pairs of data drivers 321 and 322, 323 and 324, 325 and 326 and 327 and 328 through respective data lines 341, 342, 343 and 344. That is, the timing controller 310 transmits the subfield data in parallel to the pairs of data drivers through the data lines 341, 342, 343, and 344, and in each pair of data drivers, the timing controller 310 sequentially transmits the subfield data through corresponding data lines. For example, the timing controller 310 sequentially transmits subfield data for 64 address electrodes (A1-A64 in FIG. 2) corresponding to the pair of data drivers 321 and 322, through the data line 341. A distance between data drivers 321, 323, 325 and 327 (a first group) is longer than a distance between data driver 321 of the first group and a data driver 322 of a second group comprising data drivers 32, 324, 326 and 238.

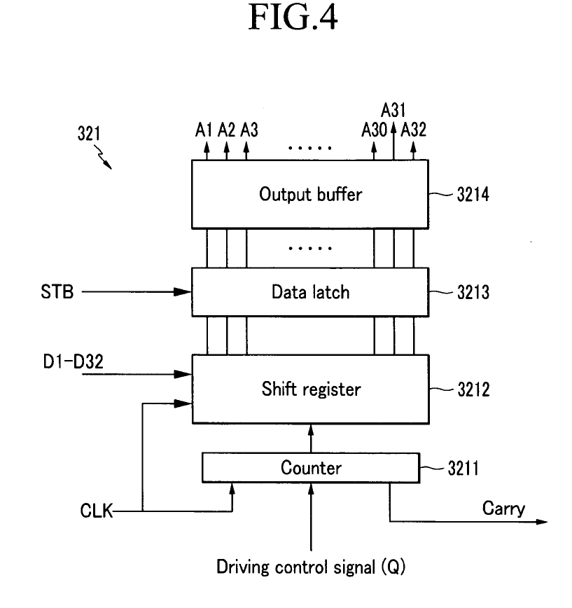

For even numbered data drivers 322, 324, 326, and 328 among the data drivers 321-328 of the address electrode driver 300 according to the first exemplary embodiment of the present invention, operation/non-operation of them are not directly controlled by the timing controller 310, and instead, they operate based on carry signals from adjacent data drivers 321, 323, 325, and 327. For example, in response to the driving control signal Q, the odd numbered data driver 321 in the adjacent pair of data drivers 321 and 322 stores subfield data (D1-D32 in FIG. 4) corresponding to first-coming 32 address electrodes A1-A32 among the subfield data sequentially transmitted from the timing controller 310, and then outputs the carry signal. In response to the carry signal, the even numbered data driver 322 stores the subfield data corresponding to subsequent 32 address electrodes A33-A64. Such a data driver is hereinafter described in detail with reference to FIG. 4.

FIG. 4 shows an exemplary data driver according to an embodiment of the present invention.

As shown in FIG. 4, the data driver 321 includes a counter 3211, a shift register 3212, a data latch 3213, and an output buffer/level shifter 3214.

At receiving the driving control signal Q from the timing controller 310, the counter 3211 sends a start signal corresponding to the driving control signal Q to the shift register 3212. The start signal may be the same with the driving control signal Q.

The shift register 3212 synchronizes the driving control signal Q (i.e., subfield data D1-D32 received from the timing controller 310 in response to the start signal) with a clock signal CLK, and then outputs subfield data D1-D32 to the data latch 3213 after sequentially shifting it.

The data latch 3213 stores the subfield data received from the shift register 3212, and outputs subfield data to the output buffer/level shifter 3214 synchronously with a strobe signal STB.

The output buffer/level shifter 3214 generates a display data signal by converting (or level shifting) the subfield data received from the data latch 3213 into a corresponding driving voltage, and outputs the generated display data signal to address electrodes A1-A32.

The counter 3211 counts until all subfield data are outputted from the shift register 3212 to the data latch 3213. When a last subfield data is outputted from the shift register 3212 to the data latch 3213, the counter 3211 generates a carry signal corresponding to the-driving control signal Q and transmits it to a counter (not shown) of the data driver 322. The data driver 322 is driven by the carry signal, and then samples subfield data (D33-D64, not shown) inputted from the timing controller (310 in FIG. 2).

The same as the data driver 322 is driven by receiving the carry signal from the data driver 321, the data drivers 324, 326, and 328 are driven by receiving a carry signal from the data drivers 323, 325, and 327, and they sample the subfield data inputted from the timing controller (310 in FIG. 2).

When the subfield data are stored in data latches of all data drivers 321-328 included in the address electrode driver 300, in response to the strobe signal STB, display data signals converted from the subfield data by the output buffer/level shifter 3214 are simultaneously outputted from all data drivers 321-328 to the address electrode A1-Am.

The address electrode driver 300, according to an exemplary embodiment of the present invention, repeats the outputting operation of the display data signal corresponding to subfield data to the address electrode A1-Am for each subfield, and thereby, turn-on/turn-off of each cell is determined for each subfield.

According to the address electrode driver 300 according to the first exemplary embodiment of the present invention shown in FIG. 3, the driving control signal Q is applied to the odd numbered data drivers 321, 323, 325, and 327 among the plurality of data drivers, and the even numbered data drivers 322, 324, 326, and 328 are driven by the carry signal outputted from the odd numbered data drivers 321, 323, 325, and 327. It should be understood that FIG. 3 is merely an exemplary embodiment of the address electrode driver 300 according to the present invention, and the address electrode driver 300 may be formed in a different way.

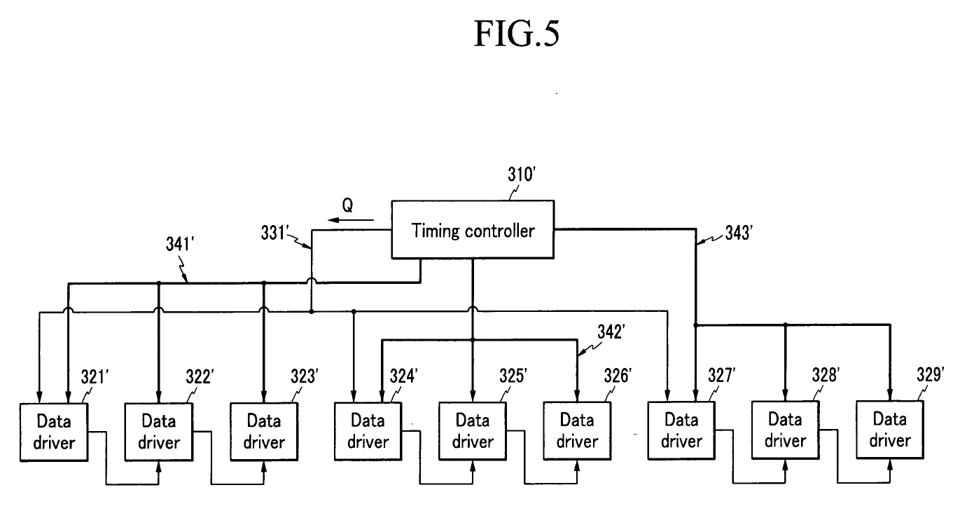

FIG. 5 shows an address electrode driver according to a second exemplary embodiment of the present invention.

As shown in FIG. 5, the address electrode driver (300 in FIG. 2) according to the second exemplary embodiment of the present invention includes a timing controller 310′ and a plurality of data drivers 321′-329′. Internal arrangement of a plurality of data drivers 321′-329′ included in the address electrode driver 300 according to the second exemplary embodiment of the present invention may be formed as the data driver 321 according to an exemplary embodiment of the present invention shown in FIG. 4.

According to the address electrode driver 300 according to the second exemplary embodiment of the present invention shown in FIG. 5, a driving control signal Q is applied to three data drivers 321′, 324′, and 327′ among the plurality of data drivers 321′-329′.

Driving of the three data drivers 321′, 322′, and 323′ as an example is as follows. The driving control signal Q is applied to one data driver 321′ among the three data drivers 321′, 322′, and 323′. The data driver 322′ arranged most adjacently to the data driver 321′ among the remaining two data driver 322′ and 323′ is driven by receiving a carry signal outputted from the data driver 321′ that received the driving control signal Q. The data driver 323′ is driven by receiving a carry signal outputted from the data driver 322′.

The same operation is applied to respective data driver groups of three adjacent data drivers 321′-323′, 324′-326′, and 327′-329′ in the plurality of data drivers 321′-329′ included in the address electrode driver 300 according to the second exemplary embodiment of the present invention.

The timing controller 310′ sequentially transmits the subfield data to the three data drivers 321′, 322′, and 323′ through a single data line 341′.

The timing controller 310′ simultaneously applies the driving control signal Q to the three data drivers 321′, 324′, and 327′ among the plurality of data drivers 321′-329′ through a driving control signal line 331′. For each subfield, the timing controller 310′ sequentially transmits the same subfield data to respective groups of three adjacent data drivers 321′-323′, 324′-326′, and 327′-329′ through respective data lines 341′, 342′, and 343′. That is, the timing controller 310′ transmits the subfield data in parallel to the groups of three data drivers through the data lines 341′, 342′, and 343′, and in each group of data drivers, the timing controller 310 sequentially transmits the subfield data through corresponding data lines. For example, the timing controller 310′ sequentially transmits subfield data for 64 address electrodes (A1-A64 in FIG. 1) corresponding to the group of data drivers 321′-323′, through the data line 341′.

It may be understood that, differently from FIG. 3 and FIG. 5, it may be designed that the driving control signal Q is applied to one data driver per a group of more than three data drivers, as a variation of an exemplary embodiment of the present invention. In this case, it may also be understood that the same subfield maybe transmitted from the timing controller to the group of more than three data driver through a single data line.

According to an address electrode driver of an exemplary embodiment of the present invention, adjacent data drivers among a plurality of data drivers may be driven by a time-division manner using a single driving control signal inputted from a timing controller. Therefore, the number of driving control signal lines may be reduced, and thereby an area for a circuit may be decreased. In addition, a length deviation of a driving control signal line connecting from a timing controller to data drivers can be minimized, and thus a sampling error may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device, comprising:
a plurality of address electrodes;
a controller that divides a frame into a plurality of subfields each having a weight value, and converts an input video signal into a plurality of subfield data that represent turn-on/turn-off for respective subfields;
a timing controller that receives the plurality of subfield data and outputs the plurality of subfield data and a driving control signal;
a first group of data drivers that, in response to the driving control signal, generate display data to be applied to a first group of corresponding address electrodes among the plurality of address electrodes by sequentially sampling corresponding subfield data among the plurality of subfield data, said first group of data drivers then outputting respective carry signals; and
a second group of data drivers that, in response to the carry signals, generate display data to be applied to a second group of corresponding address electrodes among the plurality of address electrodes.

2. The plasma display device of claim 1, each data driver of the first group comprising:
a data latch;
a shift register that sequentially samples the corresponding subfield data and stores the sampled subfield data in the data latch;
a counter that drives the shift register in response to the driving control signal, and outputs the carry signal when the shift register finishes sampling of all the corresponding subfield data; and
an output buffer that converts the subfield data outputted from the data latch to the display data, and outputs the display data.

3. The plasma display device of claim 2, wherein a distance between data drivers of the first group is longer than a distance between a data driver of the first group and a data driver of the second group closest thereto.

4. A driving apparatus of a plasma display device that applies display a data signal to a plurality of address electrodes, the driving apparatus comprising:
a plurality of data drivers that generate display data by sequentially sampling inputted subfield data and apply the generated display data to corresponding address electrodes among the plurality of address electrodes, the plurality of data drivers being grouped into a plurality of groups each including at least two data drivers; and
a timing controller that supplies the subfield data to respective ones of the plurality of data drivers, the timing controller supplying a first control signal for a sampling operation to a first data driver among data drivers of each group, and the first data driver generates a second control signal for a sampling operation and supplies the second control signal to a second data driver arranged closest to the first data driver in the same group with the first data driver.

5. The driving apparatus of claim 4, wherein the timing controller sequentially supplies the subfield data to the at least two data drivers included in respective groups through a same data line.

6. The driving apparatus of claim 4, wherein the second data driver generates a third control signal for a sampling operation, and supplies the third control signal to a third data driver closest to the second data driver in the same group with the second data driver where the second data driver is different from the first data driver.

7. A driving method of a plasma display device for applying a display data signal to a plurality of address electrodes, the driving method comprising:
outputting a driving control signal;
sequentially sampling subfield data inputted in response to the driving control signal and storing the sampled subfield data in a first data driver;
generating a carry signal when the sampling of the first data driver is finished;
sequentially sampling subfield data, inputted in a second data driver, in response to the carry signal and storing the sampled subfield data;
converting subfield data stored in the first and second data drivers to the display data signal; and
applying the display data signal to the plurality of address electrodes.
